(19) United States
(12) Patent Application Publication
(10) Pub. No.: US 2026/0143171 A1
(43) Pub. Date: May 21, 2026

(54) IMAGE ENCODING/DECODING METHOD, DEVICE, AND RECORDING MEDIUM FOR STORING BITSTREAM BASED ON POST-DECODING FILTER

(71) Applicant: LG ELECTRONICS INC., Seoul (KR)

(72) Inventors: Hendry TAN, Seoul (KR); Jung Hak NAM, Seoul (KR); Jaehyun LIM, Seoul (KR); Seung Hwan KIM, Seoul (KR)

(73) Assignee: LG ELECTRONICS INC., Seoul (KR)

(21) Appl. No.: 19/118,695

(22) PCT Filed: Oct. 4, 2023
(86) PCT No.: PCT/KR2023/015238

§ 371 Date: Apr. 4, 2025

Related U.S. Application Data
(60) Provisional application No. 63/413,604, filed on Oct. 5, 2022.
(60) Provisional application No. 63/413,607, filed on Oct. 5, 2022.

(51) Int. Cl. H04N 19/80; H04N 19/70; H04N 19/85

(52) U.S. Cl. CPC H04N 19/80; H04N 19/70; H04N 19/85

(57) ABSTRACT

An image encoding/decoding method and device are provided. A video decoding method according to the present disclosure comprises the steps of: receiving a bitstream including video information; and generating a reconstructed picture by restoring the current picture on the basis of the image information, wherein the image information may include a post-filter hint SEI message regarding a post-filter to be applied to the reconstructed picture.

### CROSS-REFERENCE TO RELATED APPLICATIONS

This application is the National Stage filing under 35 U.S.C. 371 of International Application No. PCT/KR2023/015238, filed on Oct. 4, 2023, which claims the benefit of U.S. Provisional Application No. 63/413,604, filed on Oct. 5, 2022, and 63/413,607, filed on Oct. 5, 2022, the contents of which are all hereby incorporated by reference herein in their entireties.

### TECHNICAL FIELD

The present disclosure relates to an image encoding/decoding method and apparatus, and a recording medium for storing a bitstream, and more particularly, to an image encoding/decoding method and apparatus based on a post-decoding filter, and a recording medium for storing a bitstream generated by the video encoding method/apparatus of the present disclosure.

### BACKGROUND

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### SUMMARY

An object of the present disclosure is to provide an image encoding/decoding method and apparatus with improved encoding/decoding efficiency.

Another object of the present disclosure is to provide an image encoding/decoding method and apparatus for performing intra prediction mode.

Another object of the present disclosure is to provide an image encoding/decoding method and apparatus for performing inter prediction mode.

Another object of the present disclosure is to provide an image encoding/decoding method and apparatus based on a post-decoding filter.

Another object of the present disclosure is to provide an image encoding/decoding method and apparatus that include a post-filter hint SEI message in a bitstream.

Another object of the present disclosure is to provide a non-transitory computer-readable recording medium for storing a bitstream generated by an image encoding method or apparatus according to the present disclosure.

Another object of the present disclosure is to provide a non-transitory computer-readable recording medium storing a bitstream received, decoded and used to reconstruct an image by an image decoding apparatus according to the present disclosure.

Another object of the present disclosure is to provide a method of transmitting a bitstream generated by an image encoding method or apparatus according to the present disclosure.

It will be appreciated by persons skilled in the art that the objects that could be achieved with the present disclosure are not limited to what has been particularly described hereinabove and the above and other objects that the present disclosure could achieve will be more clearly understood from the following detailed description.

According to one embodiment of the present disclosure, provided herein is an image decoding method performed by an image decoding apparatus. The method may include receiving a bitstream containing image information, and generating a reconstructed picture by reconstructing a current picture based on the image information, wherein the image information may include a post-filter hint Supplemental Enhancement Information (SEI) message related to a post-filter to be applied to the reconstructed picture.

According to one embodiment of the present disclosure, the post-filter hint SEI message may contain filter coefficient information indicating whether a filter coefficient for chroma components is present.

According to one embodiment of the present disclosure, the post-filter hint SEI message may contain chroma format information indicating chroma sampling related to luma sampling, wherein, based on the chroma format information, filter coefficient information indicating whether a filter coefficient for chroma components is present may be acquired from the post-filter hint SEI message.

According to one embodiment of the present disclosure, based on the filter coefficient information, single-set filter coefficient information indicating whether the same filter coefficient set is applied to all the chroma components may be acquired from the post-filter hint SEI message.

According to one embodiment of the present disclosure, the post-filter hint SEI message may include filter hint cancel information indicating whether to cancel use of a post-filter hint SEI message used for an earlier picture in output order. Based on the filter hint cancel information, filter hint persistence information indicating whether the post-filter hint SEI message is used for other pictures following the current picture in the output order may be acquired from the post-filter hint SEI message. Based on the filter hint persistence information having a first value, the post-filter hint SEI message may be applied to only a current reconstructed picture. Based on the filter hint persistence information having a second value, the post-filter hint SEI message may be applied to other pictures in a current layer following the current reconstructed picture in the output order.

According to one embodiment of the present disclosure, based on the filter hint persistence information having the second value, the post-filter hint SEI message may be applied until a new coded layer video sequence (CLVS) starts in the current layer.

According to one embodiment of the present disclosure, based on the filter hint persistence information having the second value, the post-filter hint SEI message may be applied until a next picture in the current layer within an access unit (AU) related to the post-filter hint SEI message in the output order is output.

According to one embodiment of the present disclosure, the post-filter hint SEI message may contain filter hint persistence information indicating persistence of the post-filter hint SEI message for a current layer. Based on the filter hint persistence information having a first value, the post-filter hint SEI message may be applied to only a current reconstructed picture. Based on the filter hint persistence information having a second value, the post-filter hint SEI message may be applied to other pictures in a current layer following the current reconstructed picture in output order. Based on the filter hint persistence information having a third value, the persistence of the post-filter hint SEI message is canceled.

According to one embodiment of the present disclosure, based on the filter hint persistence information having the second value, the post-filter hint SEI message may be applied until a new CLVS starts in the current layer.

According to one embodiment of the present disclosure, based on the filter hint persistence information having the second value, the post-filter hint SEI message may be applied until a next picture in the current layer within an AU related to the post-filter hint SEI message in the output order is output.

According to one embodiment of the present disclosure, the post-filter hint SEI message may contain filter hint availability information indicating whether the post-filter hint SEI message is available. Based on the filter hint availability information, filter hint persistence information indicating whether the post-filter hint SEI message is used for other pictures following the current picture in the output order may be acquired from the post-filter hint SEI message, wherein the filter hint persistence information is determined based on the filter hint availability information. Based on the filter hint persistence information having a first value, the post-filter hint SEI message may be applied to only a current reconstructed picture. Based on the filter hint persistence information having a second value, the post-filter hint SEI message may be applied to other pictures in a current layer following the current reconstructed picture in the output order.

According to one embodiment of the present disclosure, provided herein is an image encoding method performed by an image encoding apparatus. The method may include encoding image information related to a current picture, and transmitting a bitstream containing the image information, wherein the image information may include a post-filter hint SEI message related to a post-filter applied to the current picture.

According to one embodiment of the present disclosure, a computer-readable recording medium storing a bitstream generated by the image encoding method may be provided.

According to one embodiment of the present disclosure, a method of transmitting a bitstream generated by an image encoding method may be provided. The image encoding method may include encoding image information related to a current picture, and transmitting a bitstream containing the image information, wherein the image information may include a post-filter hint SEI message related to a post-filter applied to the current picture.

According to the present disclosure, an image encoding/decoding method and apparatus with improved encoding/decoding efficiency may be provided.

According to the present disclosure, an image encoding/decoding method and apparatus for performing intra prediction mode may be provided.

According to the present disclosure, an image encoding/decoding method and apparatus for performing inter prediction mode may be provided.

According to the present disclosure, an image encoding/decoding method and apparatus based on a post-decoding filter may be provided.

According to the present disclosure, an image encoding/decoding method and apparatus that include a post-filter hint SEI message in a bitstream may be provided.

According to the present disclosure, a non-transitory computer-readable recording medium for storing a bitstream generated by an image encoding method or apparatus according to the present disclosure may be provided.

According to the present disclosure, a non-transitory computer-readable recording medium for storing a bitstream received and decoded by an image decoding apparatus so as to be used to reconstruct an image may be provided.

According to the present disclosure, a method of transmitting a bitstream generated by an image encoding method or apparatus according to the present disclosure may be provided.

The effects obtainable in the present disclosure are not limited to the above-mentioned effects, and other effects not mentioned may be clearly understood by those of ordinary skill in the art from the following description.

### BRIEF DESCRIPTION OF THE DRAWINGS

FIG. 1 is a view schematically illustrating a video coding system, to which an embodiment of the present disclosure is applicable.

FIG. 2 is a view schematically illustrating an image encoding apparatus, to which an embodiment of the present disclosure is applicable.

FIG. 3 is a view schematically illustrating an image decoding apparatus to which an embodiment of the present disclosure is applicable.

FIG. 4 illustrates one example of a coding layer and structure to which embodiments according to the present disclosure are applicable.

FIG. 5 is a flowchart of an image encoding method according to the present disclosure.

FIG. 6 is a flowchart of an image decoding method according to the present disclosure.

FIG. 7 is a diagram illustrating an exemplary content streaming system to which embodiments of the present disclosure are applicable.

### DETAILED DESCRIPTION

Hereinafter, embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure. In the present disclosure, a “video” may mean a set of images over time.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs).

In the present disclosure, a “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The luma component block of the current block may be expressed by including an explicit description of a luma component block such as “luma block” or “current luma block. In addition, the “chroma component block of the current block” may be expressed by including an explicit description of a chroma component block, such as “chroma block” or “current chroma block”.

In the present disclosure, the term “/” and “,” should be interpreted to indicate “and/or.” For instance, the expression “A/B” and “A, B” may mean “A and/or B.” Further, “A/B/C” and “A/B/C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

In the present disclosure, “at least one of A, B, and C” may mean “only A,” “only B.” “only C,” or “any and all combinations of A, B, and C.” In addition, “at least one A, B or C” or “at least one A, B and/or C” may mean “at least one A, B and C.”

Parentheses used in the present disclosure may mean “for example.” For example, if “prediction (intra prediction)” is indicated, “intra prediction” may be proposed as an example of “prediction.” In other words, “prediction” in the present disclosure is not limited to “intra prediction,” and “intra prediction” may be proposed as an example of “prediction.” In addition, even when “prediction (i.e., intra prediction)” is indicated, “intra prediction” may be proposed as an example of “prediction.”

### Overview of Video Coding System

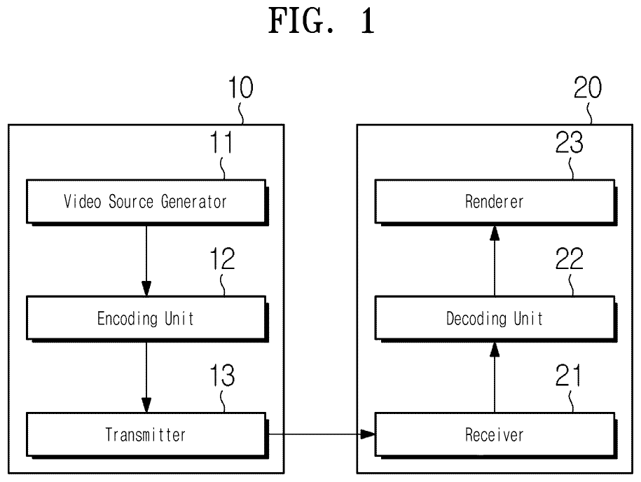

FIG. 1 is a view showing a video coding system to which an embodiment of the present disclosure is applicable.

The video coding system according to an embodiment may include an encoding apparatus 10 and a decoding apparatus 20. The encoding apparatus 10 may deliver encoded video and/or image information or data to the decoding apparatus 20 in the form of a file or streaming via a digital storage medium or network.

The encoding apparatus 10 according to an embodiment may include a video source generator 11, an encoding unit (encoder) 12 and a transmitter 13. The decoding apparatus 20 according to an embodiment may include a receiver 21, a decoding unit (decoder) 22 and a renderer 23. The encoding unit 12 may be called a video/image encoding apparatus, and the decoding unit 22 may be called a video/image decoding apparatus. The transmitter 13 may be included in the encoding unit 12. The receiver 21 may be included in the decoding unit 22. The renderer 23 may include a display and the display may be configured as a separate device or an external component.

The video source generator 11 may acquire a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may obtain the encoded video/image information or data output in the form of a bitstream and forward it to the receiver 21 of the decoding apparatus 20 or another external object through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The transmitter 13 may be provided as a transmission device separate from the encoding apparatus 120, and in this case, the transmission device may include at least one processor that acquires encoded video/image information or data output in the form of a bitstream and a transmission unit for transmitting it in the form of a file or streaming. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

### Overview of Image Encoding Apparatus

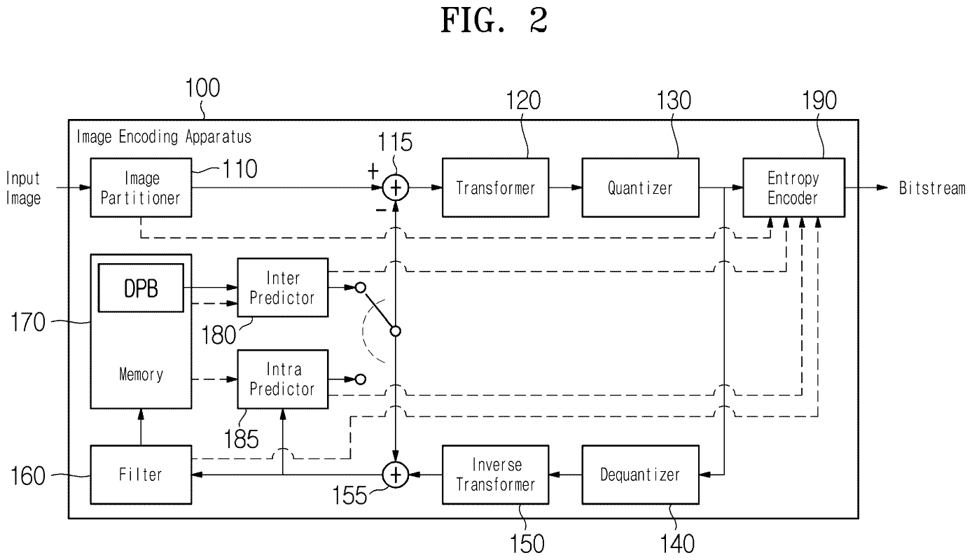

FIG. 2 is a view schematically showing an image encoding apparatus, to which an embodiment of the present disclosure is applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter predictor 180, an intra predictor 185 and an entropy encoder 190. The inter predictor 180 and the intra predictor 185 may be collectively referred to as a “predictor”. The transformer 120, the quantizer 130, the dequantizer 140 and the inverse transformer 150 may be included in a residual processor. The residual processor may further include the subtractor 115.

All or at least some of the plurality of components constituting the image encoding apparatus 100 may be implemented as one hardware component (e.g., the image encoding apparatus 100 or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. For example, the processing unit may be called a coding unit (CU). The coding unit may be acquired by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The predictor (the inter predictor 180 or the intra predictor 185) may perform prediction on a block to be processed (current block) and generate a predicted block including prediction samples for the current block. The predictor may determine whether intra prediction or inter prediction is applied on a current block or CU basis. The predictor may generate various kinds of information related to prediction of the current block and transmit the generated information to the entropy encoder 190. The information on the prediction may be encoded by the entropy encoder 190 and output in the form of a bitstream.

The intra predictor 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example. 33 directional prediction modes or 65 directional prediction modes according to the degree of detail of the prediction direction. However, this is merely an example, more or less directional prediction modes may be used depending on a setting. The intra predictor 185 may determine the prediction mode applied to the current block by using a prediction mode applied to a neighboring block.

The inter predictor 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter predictor 180 may construct a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The predictor may generate a prediction signal based on various prediction methods and prediction techniques described below. For example, the predictor may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the predictor may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the predictor may be used to generate a reconstructed signal or to generate a residual signal. The subtractor 115 may generate a residual signal (residual block or residual sample array) by subtracting the prediction signal (predicted block or prediction sample array) output from the predictor from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all earlier reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block type into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter predictor 180 or the intra predictor 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

Luma mapping with chroma scaling (LMCS) is applicable in a picture encoding and/or reconstruction process.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter predictor 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter predictor 180. The memory 170 may store the motion information of the block from which the motion information in the current picture is derived (or encoded) and/or the motion information of the blocks in the picture that have already been reconstructed. The stored motion information may be transmitted to the inter predictor 180 and used as the motion information of the spatial neighboring block or the motion information of the temporal neighboring block. The memory 170 may store reconstructed samples of reconstructed blocks in the current picture and may transfer the reconstructed samples to the intra predictor 185.

### Overview of Image Decoding Apparatus

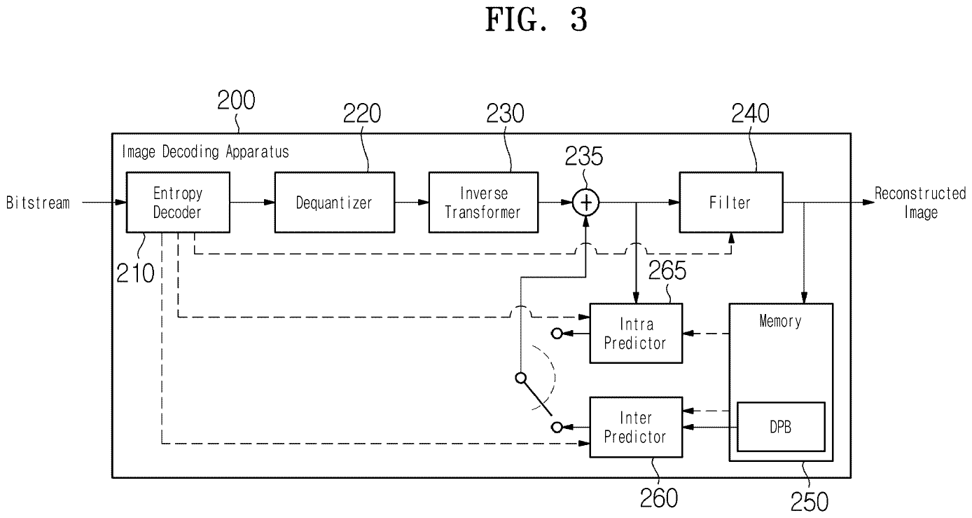

FIG. 3 is a view schematically showing an image decoding apparatus, to which an embodiment of the present disclosure is applicable.

As shown in FIG. 3, the image decoding apparatus 200 may include an entropy decoder 210, a dequantizer 220, an inverse transformer 230, an adder 235, a filter 240, a memory 250, an inter predictor 260 and an intra predictor 265. The inter predictor 260 and the intra predictor 265 may be collectively referred to as a “predictor.” The dequantizer 220 and the inverse transformer 230 may be included in a residual processor.

All or at least some of a plurality of components constituting the image decoding apparatus 200 may be implemented as a hardware component (e.g., the image decoding apparatus 200 or a processor) according to an embodiment. In addition, the memory 170 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied by the image encoding apparatus 100. Thus, the processing unit of decoding may be a coding unit, for example. The coding unit may be acquired by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus 100 of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus 200 may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding. CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the predictor (the inter predictor 260 and the intra predictor 265), and the residual value on which the entropy decoding was performed in the entropy decoder 210, that is, the quantized transform coefficients and related parameter information may be input to the dequantizer 220. In addition, information on filtering among information decoded by the entropy decoder 210 may be provided to the filter 240. A receiver (not shown) for receiving a signal output from the image encoding apparatus 100 may be further configured as an internal/external element of the image decoding apparatus 200, or the receiver may be a component of the entropy decoder 210.

The image decoding apparatus 200 according to the present disclosure may be referred to as a video/image/picture decoding apparatus. The image decoding apparatus 200 may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter predictor 260 or the intra predictor 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus 100. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The predictor may perform prediction on the current block and generate a predicted block including prediction samples for the current block. The predictor may determine whether intra prediction or inter prediction is applied to the current block based on the information on the prediction output from the entropy decoder 210 and may determine a specific intra/inter prediction mode (prediction technique).

It is the same as described regarding the predictor of the image encoding apparatus 100 that the predictor may generate the prediction signal based on various prediction methods (techniques), which will be described later.

The intra predictor 265 may predict the current block by referring to the samples in the current picture. The description of the intra predictor 185 is equally applied to the intra predictor 265.

The inter predictor 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the predictor (including the inter predictor 260) and/or the intra predictor 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter predictor 260. The memory 250 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 250 may store reconstructed samples of reconstructed blocks in the current picture and transfer the reconstructed samples to the intra predictor 265.

In the present disclosure, the embodiments described regarding the filter 160, the inter predictor 180, and the intra predictor 185 of the image encoding apparatus 100 may be equally or correspondingly applied to the filter 240, the inter predictor 260, and the intra predictor 265 of the image decoding apparatus 200.

### Coding Layers and Structure

A coded video/image according to the present disclosure may be processed according to, for example, the coding layers and structure described hereinafter.

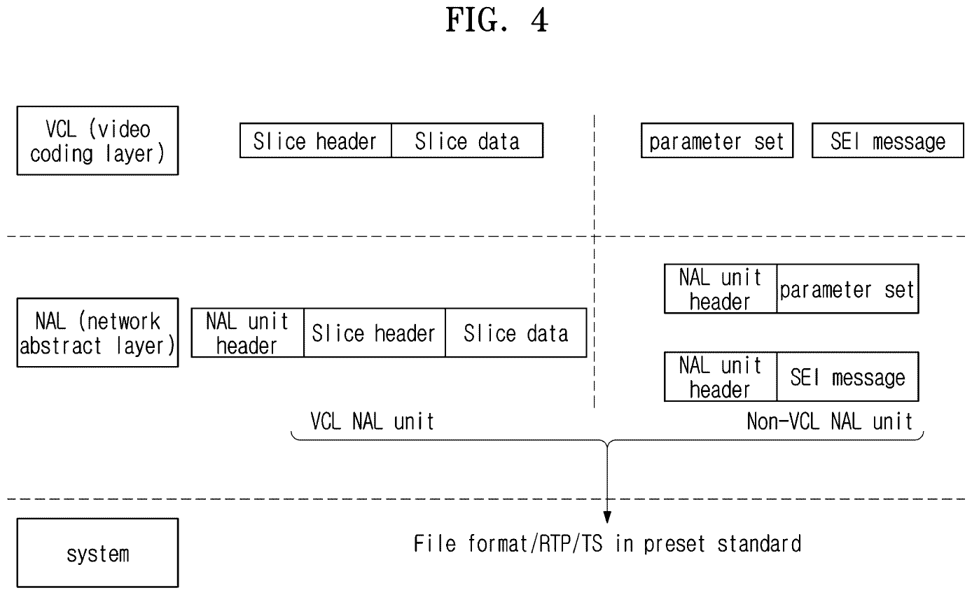

FIG. 4 is a diagram illustrating a layered structure for a coded image.

A coded image is divided into a video coding layer (VCL) that deal with decoding of the image and the image itself, a lower-level system configured to transmit and store encoded information, and a network abstraction layer (NAL), which is present between the VCL and the lower-level system and is responsible for a network adaptation function.

In the VCL, VCL data including compressed image data (slice data) may be generated, or a parameter set including information such as a picture parameter set (PPS), a sequence parameter set (SPS), and a video parameter set (VPS), or a supplemental enhancement information (SEI) message additionally needed in the process of decoding an image may be generated.

In the NAL, a NAL unit may be generated by adding header information (NAL unit header) to the raw byte sequence payload (RBSP) generated in the VCL. Here, the RBSP refers to the slice data, parameter set, SEI message, and the like generated in the VCL. The NAL unit header may include NAL unit type information specified according to RBSP data contained in the NAL unit.

As illustrated in FIG. 4, the NAL unit may be divided into a VCL NAL unit and a non-VCL NAL unit according to the RBSP generated in the VCL. The VCL NAL unit may represent a NAL unit containing information (slice data) about an image, and the non-VCL NAL unit may represent a NAL unit containing information (parameter set or SEI message) needed to decode the image.

The VCL NAL unit and the non-VCL NAL unit may be transmitted over the network by attaching header information according to the data standard for the lower-level system. For example, the NAL units may be transformed into a data format of a predetermined standard, such as H.266/VVC file format, Real-time Transport Protocol (RTP), or Transport Stream (TS), and transmitted over various networks.

As described above, for the NAL unit, the NAL unit type may be specified according to the RBSP data structure included in the NAL unit, and information about the NAL unit type may be stored in the NAL unit header and signaled.

For example, the unit types may be largely classified into a VCL NAL unit type and a non-VCL NAL unit type according to whether the NAL unit contains information about the image (slice data). The VCL NAL unit type may be classified according to the characteristics and type of a picture included in the VCL NAL unit, and the non-VCL NAL unit type may be classified according to the type of a parameter set.

The following is an example of an NAL unit type specified according to the type of the parameter set included in the non-VCL NAL unit type.
APS (Adaptation Parameter Set) NAL unit: Type of a NAL unit including APS
DPS (Decoding Parameter Set) NAL unit: Type of a NAL unit including DPS
Video Parameter Set (VPS) NAL unit: Type of a NAL unit including VPS
Sequence Parameter Set (SPS) NAL unit: Type of a NAL unit including SPS
PPS (Picture Parameter Set) NAL unit: Type of a NAL unit including PPS

The NAL unit types described above have syntax information for the NAL unit types. The syntax information may be stored in the NAL unit header and signaled. For example, the syntax information may be nal_unit_type, and the NAL unit types may be specified by values of nal_unit_type.

The slice header (slice header syntax) may include information/parameters that are applicable to the slices in common. The APS (APS syntax) or the PPS (PPS syntax) may include information/parameters that may be applied to one or more slices or pictures in common. The APS (APS syntax) or the PPS (PPS syntax) may include information/parameters applicable to one or more slices or pictures in common. The SPS (SPS syntax) may include information/parameters applicable to one or more sequences in common. The VPS syntax may include information/parameters applicable to multiple layers in common. The DPS syntax may include information/parameters applicable throughout the video in common. The DPS may include information/parameters related to concatenation of a coded video sequence (CVS). In the present disclosure, a high level syntax (HLS) may include at least one of an APS syntax, a PPS syntax, an SPS syntax, a VPS syntax, a DPS syntax, or a slice header syntax.

In the present disclosure, video/image information encoded by the image encoding apparatus 100 and signaled to the image decoding apparatus 200 in the form of a bitstream may include information related to in-picture partitioning, intra/inter prediction information, residual information, in-loop filtering information information contained in the slice header, information contained in the APS, information contained in the PPS, information contained in the SPS, and/or information in the VPS.

### SEI Message—Dependent Random Access Point (DRAP)

A DRAP picture may reference only a previous Intra Random Access Point (IRAP) picture. When the IRAP picture is available, the DRAP picture may be an inter-coded picture that provides a random access point to the bitstream of the DRAP picture. The DRAP picture may be indicated in the bitstream by an SEI message.

A picture related to a DRAP indication SEI message may be referred to as a DRAP picture. An example of the DRAP indication SEI message is shown in Table 1.

TABLE 1

Descriptor

dependent_rap_indication( payloadSize ) {
}

The presence of the DRAP indication SEI message may indicate restrictions on the references of the picture and the order of the picture. These restrictions may enable the image decoding apparatus 200 to appropriately decode the DRAP picture. Further, such restrictions may enable the image decoding apparatus 200 to appropriately decode pictures that are present in the same layer and are subsequent in both the decoding order and the output order, without the need to decode any other pictures in the same layer except the IRAP picture related to the DRAP picture.

The restrictions indicated by the presence of the DRAP indication SEI message may include the followings.
The DRAP picture is a trailing picture.
The DRAP picture has a temporal sublayer identifier equal to 0.
The DRAP picture does not include any pictures that are present in the same layer within the active entry in the reference picture list, except for the IRAP picture related to the DRAP picture.
Any picture that is present in the same layer and trails the DRAP picture in both decoding order and output order does not include as an active entry in the reference picture list any picture that is present in the same layer and precedes the DRAP picture in decoding order or output order, except for the IRAP picture related to the DRAP picture.

### SEI Message—Extended DRAP (EDRAP)

An EDRAP picture may be a DRAP picture that depends on only some pictures in a picture set. The picture set may include a related IRAP picture, and a specific EDRAP picture between the related IRAP picture and the specific EDRAP picture in the decoding order. As long as a dependent IRAP picture or EDRAP picture is provided, the EDRAP picture may be used as a random access point.

A picture related to the EDRAP indication SEI message may be referred to as an EDRAP picture.

The presence of the EDRAP indication SEI message may indicate restrictions on the references of the picture and the order of the picture. These restrictions may enable the image decoding apparatus 200 to appropriately decode the EDRAP picture. Further, such restrictions may enable the image decoding apparatus 200 to appropriately decode pictures that are present in the same layer and are subsequent in both the decoding order and the output order, without the need to decode any other pictures in the same layer except the list referenceablePictures of the pictures. Here, the list referenceablePictures of pictures may be composed of a list of IRAP or EDRAP pictures in decoding order that are present within the same coded layer video sequence (CLVS) and identified by the syntax element edrap_ref_rap_id[i].

The restrictions indicated by the presence of the EDRAP indication SEI message may include the followings.
The EDRAP picture is a trailing picture.
The EDRAP picture has a temporal sublayer identifier equal to 0.
The EDRAP picture does not include any pictures that are present in the same layer within the active entry in the reference picture list, except for the referenceablePictures.
Any picture that is present in the same layer and trails the EDRAP picture in both decoding order and output order does not include as an active entry in the reference picture list any picture that is present in the same layer and precedes the EDRAP picture in decoding order or output order, except for the referenceablePictures.
A picture contained in the referenceablePictures does not include as an active entry in the reference picture list a picture that is present in the same layer and is not present in an earlier position in the referenceablePictures. Therefore, the first picture in the referenceablePictures does not include a picture from the same layer as an active entry in the reference picture list, even if the picture is an EDRAP picture rather than an IRAP picture.

An example of the EDRAP indication SEI message is shown in Table 2.

TABLE 2

| | Descriptor |
|---|---|
| extended_drap_indication( payloadSize ) { | |
| edrap_rap_id_minus1 | u(16) |
| edrap_leading_pictures_decodable_flag | u(1) |
| edrap_reserved_zero_12bits | u(12) |
| edrap_num_ref_rap_pics_minus1 | u(3) |
| for( i = 0; i <= edrap_num_ref_rap_pics_minus1; i++ ) | |
| edrap_ref_rap_id[ i ] | u(16) |
| } | |

The value of edrap_rap_id_minus1 plus 1 indicates the RAP picture identifier RapPicId for the EDRAP picture. Each IRAP or EDRAP picture is related to a RapPicId. The RapPicId value of an IRAP picture may be inferred to be 0. The RapPicId values for any two EDRAP pictures related to the same IRAP picture must be different from each other.

The edrap_leading_pictures_decodable_flag equal to 1 indicates that all the following restrictions are applied.
Pictures that are present in the same layer and follow the EDRAP picture in decoding order should be trailed in the output order compared to pictures that are present in the same layer and precede the EDRAP picture in the decoding order.
A picture that is present in the same layer and follows the EDRAP picture in decoding order and precedes the EDRAP picture in output order should not include the picture that is present in the same layer and precedes the EDRAP picture in decoding order as an active entry in the reference picture list, except for referenceablePictures.

A value of 0 of edrap_leading_pictures_decodable_flag does not impose the above restrictions.

The value of edrap_reserved_zero_12bits should be equal to 0 in the bitstream. Other values of edrap_reserved_zero_12bits are reserved for future definition, and the image decoding apparatus 200 should ignore the value of edrap_reserved_zero_12bits.

The value of edrap_num_ref_rap_pics_minus1 plus 1 indicates the number of IRAP or EDRAP pictures that are present in the same CLVS as the EDRAP picture and that may be included in the active entries in the reference picture list of the EDRAP picture.

edrap_ref_rap_id[i] indicates the RapPicId of the i-th RAP picture that may be included in the active entries in the reference picture list of the EDRAP picture. The i-th RAP picture should be an IRAP picture related to the current EDRAP picture, or an EDRAP picture related to the same IRAP picture as the current EDRAP picture.

### Post-Filter Hint

The SEI message in Table 3 below may provide coefficients or correlation information for the design of a post-filter for potential use in post-processing of the current picture after decoding of the current picture. This may result in improved display quality.

TABLE 3

| | Descriptor |
|---|---|
| post_filter_hint( payloadSize ) { | |
| filter_hint_size_y | ue(v) |
| filter_hint_size_x | ue(v) |
| filter_hint_type | u(2) |
| for( cIdx = 0; cIdx < ( chroma_format_idc = = 0 ? 1 : 3 | |
| ); cIdx++ ) | |
| for( cy = 0; cy < filter_hint_size_y; cy++ ) | |
| for( cx = 0; cx < filter_hint_size_x; cx++ ) | |
| filter_hint_value[ cIdx ][ cy ][ cx ] | se(v) |
| } | |

filter_hint_size_y may indicate the vertical size of the filter coefficients or correlation array. The value of filter_hint_size_y may be in the range of 1 to 15.

filter_hint_size_x may indicate the horizontal size of the filter coefficients or correlation array. The value of filter_hint_size_x may be in the range of 1 to 15.

filter_hint_type may identify the type of filter hint transmitted, as shown in Table 4 below. The value of filter_hint_type may be in the range of 0 to 2. The image decoding apparatus 200 may ignore a post-filter hint SEI message that indicates a value of 3 for filter_hint_type.

TABLE 4

| Value | Description |
|---|---|
| 0 | Coefficients of a 2D-FIR filter |
| 1 | Coefficients of two 1D-FIR filters |
| 2 | Cross-correlation matrix |

filter_hint_value[cIdx][cy][cx] may indicate the filter coefficients or elements of the cross-correlation matrix between the original and decoded signals with 16-bit precision. The value of filter_hint_value[cIdx][cy][cx] may be in the range of −231+1 to 231−1. Here, cIdx denotes the chroma component, cy denotes the counter in the horizontal direction, and cx denotes the counter in the vertical direction. Based on the value of filter_hint_type, the following may be applied.
When the value of filter_hint_type is 1, the coefficients of a two-dimensional finite impulse response (FIR) filter of size filter_hint_size_y*filter_hint_size_x may be transmitted.
Alternatively, when the value of filter_hint_type is 1, two one-dimensional FIR filters may be transmitted. In this case, filter_hint_size_y may be 2. cy set to 0 may indicate the filter coefficient of the horizontal filter. Also, cy set to 1 may indicate the filter coefficient of the vertical filter. In the filtering process, the horizontal filter may be applied first, and the result may be filtered by the vertical filter. That is, the horizontal filter may be applied first, and then the vertical filter may be applied.
Otherwise (when filter_hint_type is 2), the transmitted SEI message may indicate a cross-correlation matrix between the original signal s and the decoded signal s′.

Here, the normalized cross-correlation matrix related to the chroma component identified by cIdx with size filter_hint_size_y*filter_hint_size_x may be defined as shown in Equation 1 below.

$$filter\_hint \_value ( cIdx , cy , cx ) = \frac{1}{{( {2}^{8 + bitDepth} - 1 )}^{2} \times h \times w} {\sum }_{m = 0}^{h - 1} {\sum }_{n = 0}^{w - 1} s ( m , n ) \times {s}^{′} ( m + cy - OffsetY , n + cx - OffsetX ) \qquad [ Equation 1 ]$$

In Equation 1, s may denote a sample array of chorma components cIdx in the original picture, and s′ may denote the corresponding array in the decoded picture. h may denote the vertical height of the related chorma component. w may denote the horizontal width of the related chorma component. bitDepth may denote the bit depth of the chorma component. OffsetY may be equal to filter_hint_size_v>>1, and OffsetX may be equal to filter_hint_size_x>>1. cy may satisfy 0<=cy<filter_hint_size_y, and cx may satisfy 0<=cx<filter_hint_size_x.

The image decoding apparatus 200 may derive a Wiener post-filter from the cross-correlation matrix of the original signal and the decoded signal. Further, the image decoding apparatus 200 may derive an auto-correlation matrix of the decoded signal.

Hereinafter, the image encoding/decoding method according to various embodiments of the present disclosure will be described in detail.

### EMBODIMENT 1

A versatile video coding (VVC) codec may include picture resampling in a coded layer video sequence (CLVS), a feature that may be referred to as reference picture resampling (RPR). When RPR is available, the image decoding apparatus 200 may output a reconstructed picture of non-uniform size. However, in many cases, it may be preferred that when the reconstructed pictures are displayed, the displayed pictures maintain the same resolution/size. When reconstructed pictures of non-uniform sizes are output from the image decoding apparatus 200, additional processing (e.g., out of decoder loop) may be performed to resample some of the output pictures such that all pictures that need to be displayed have the same resolution.

Further, before the reconstructed pictures are displayed, a filtering process may be performed on the reconstructed pictures to improve visual quality and/or reduce noise and/or visual artifacts. This additional process may include a post decoding filter.

The post decoding filtering process may be controlled to provide the filter(s) that should be applied to the pictures. One method for signaling such a post filter may be to use an SEI message. While the High Efficiency Video Codec (HEVC) has a post-filter hint SEI message that may potentially be used, VVC does not have such an SEI or a similar SEI.

If a post-filter hint SEI message is used to signal a post-decoding resampling filter for reconstructed pictures in VVC and possible future codecs, the current post-filter hint SEI message may suffer from a dependency on some information related to the basic codec. Such a dependency may also include signaling of the chroma format.

To address this issue, the present disclosure proposes the following embodiments. Each of the following embodiments may be practiced individually, or a combination of two or more embodiments may be practiced.

1. A post-filter hint SEI message may be included in the VSEI document or VVC document.

2. Chroma format information may be signaled in the SEI message instead of relying on information that must be recovered from the parameter set in the encoded bitstream.

3. A flag may be signaled to indicate whether the filter coefficients for chroma are derived in the same manner as the filter coefficients for luma.

4. Alternatively, instead of signaling the chroma format, only the presence or absence of filter coefficients for the chroma component may be signaled.

5. If filter coefficients for the chroma component are present, another flag may be signaled to indicate whether there is a single filter set for the chroma component. If this flag is true, the same filter coefficient set may be applied to all chroma components.

6. The filters required for resampling the reconstructed pictures may be carried and/or signaled in a post-filter hint SEI message.

7. Alternatively, the filters required for resampling the reconstructed pictures may be carried and/or signaled in a new SEI message. Here, the syntax elements and semantics included in the new SEI message may include the syntax elements and semantics described in Sections 1 to 5 above.

### EMBODIMENT 1-1

Table 5 below shows an example of the post-filter hint SEI message. The post-filter hint SEI message in Table 5 below may provide coefficients or correlation information for the design of a post-filter for potential use in post-processing of the current picture after decoding of the current picture. Thereby, improved display quality may be obtained.

TABLE 5

| | De- |
|---|---|
| | scriptor |
| post_filter_hint( payloadSize ) { | |
| filter_hint_size_y | ue(v) |
| filter_hint_size_x | ue(v) |
| filter_hint_type | u(2) |
| filter_hint_chroma_format_idc | u(2) |
| for( cIdx = 0; cIdx < ( filter_hint_chroma_format_idc = = | |
| 0 ? 1 : 3 ); cIdx++ ) | |
| for( cy = 0; cy < filter_hint_size_y; cy++ ) | |
| for( cx = 0; cx < filter_hint_size_x; cx++ ) | |
| filter_hint_value[ cIdx ][ cy ][ cx ] | se(v) |
| } | |

filter_hint_size_y may indicate the vertical size of the filter coefficients or correlation array. The value of filter_hint_size_y may be in the range of 1 to 15.

filter_hint_size_x may indicate the horizontal size of the filter coefficients or correlation array. The value of filter_hint_size_x may be in the range of 1 to 15.

filter_hint_type may identify the type of filter hint transmitted, as shown in Table 4 above. The value of filter_hint_type may be in the range of 0 to 2. The image decoding apparatus 200 may ignore a post-filter hint SEI message that indicates a value of 3 for filter_hint_type.

filter_hint_chroma_format_idc may indicate the chroma sampling related to luma sampling, as shown in Table 6 below.

TABLE 6

| filter_hint_chroma_format_idc | Chroma format |
|---|---|
| 0 | Monochrome |
| 1 | 4:2:0 |
| 2 | 4:2:2 |
| 3 | 4:4:4 |

In monochrome sampling, there may be only one sample array, which is considered the luma array. In 4:2:0 sampling, each of the two chroma arrays may have half the height of the luma array and half the width of the luma array. In 4:2:2 sampling, each of the two chroma arrays may have the same height as the luma array and half the width of the luma array. In 4:4:4 sampling, each of the two chroma arrays may have the same height and width as the luma array. filter_hint_value[cIdx][cy][cx] may be the same as described in the section Post-filter hint above.

### EMBODIMENT 1-2

Table 7 below shows an example of the post-filter hint SEI message. The post-filter hint SEI message in Table 7 below may provide coefficients or correlation information for the design of a post-filter for potential use in post-processing of the current picture after decoding of the current picture. Thereby, improved display quality may be obtained.

TABLE 7

| | Descriptor |
|---|---|
| post_filter_hint( payloadSize ) { | |
| filter_hint_size_y | ue(v) |
| filter_hint_size_x | ue(v) |
| filter_hint_type | u(2) |
| filter_hint_chroma_format_idc | u(2) |
| if( filter_hint_chroma_format_idc != 0) | |
| filter_hint_chroma_coeff_present_flag | u(1) |
| for( cIdx = 0; cIdx < (filter_chroma_coeff_present_flag | |
| = = 0 ? 1 : 3 ); cIdx++ ) | |
| for( cy = 0; cy < filter_hint_size_y; cy++ ) | |
| for( cx = 0; cx < filter_hint_size_x; cx++ ) | |
| filter_hint_value[ cIdx ][ cy ][ cx ] | se(v) |
| } | |

The filter_hint_size_x, filter_hint_size_y, and filter_hint_type in Table 7 may be the same as those described in the section Post-filter hint above.

filter_hint_chroma_format_idc in Table 7 may indicate the chroma sampling related to luma sampling, as shown in Table 8 below.

TABLE 8

| filter_hint_chroma_format_idc | Chroma format |
|---|---|
| 0 | Monochrome |
| 1 | 4:2:0 |
| 2 | 4:2:2 |
| 3 | 4:4:4 |

In monochrome sampling in Table 8, there may be only one sample array, which is considered the luma array. In 4:2:0 sampling, each of the two chroma arrays may have half the height of the luma array and half the width of the luma array. In 4:2:2 sampling, each of the two chroma arrays may have the same height as the luma array and half the width of the luma array. In 4:4:4 sampling, each of the two chroma arrays may have the same height and width as the luma array.

When filter_hint_chroma_coeff_present_flag has a value of 1 (i.e., the second value), it may indicate that a filter coefficient for chroma is present. When filter_hint_chroma_coeff_present_flag has a value of 0 (i.e., the first value), it may indicate that no filter coefficients for chroma are present. If filter_hint_chroma_coeff_present_flag is not present, the value of filter_hint_chroma_coeff_present_flag may be inferred to be 0 (i.e., the first value).

The filter_hint_value[cIdx][cy][cx] is the same as described in the section Post-filter hint above. According to the present disclosure, when filter_hint_chroma_format_idc is not 0 (i.e., the first value) and filter_hint_chroma_coeff_present_flag is 0 (i.e., the first value), the value of filter_hint_value[1][cy][cx] and the value of filter_hint_value[2][cy][cx] may be inferred to be the value of filter_hint_value[0][cy][cx]. Here, cy may be a value in the range of 0 to filter_hint_size_y−1, and cx may be a value in the range of 0 to filter_hint_size_x−1.

### EMBODIMENT 1-3

Table 9 below shows an example of the post-filter hint SEI message. The post-filter hint SEI message in Table 9 below may provide coefficients or correlation information for the design of a post-filter for potential use in post-processing of the current picture after decoding of the current picture. Thereby, improved display quality may be obtained.

TABLE 9

| | De- |
|---|---|
| | scriptor |
| post_filter_hint( payloadSize ) { | |
| filter_hint_size_y | ue(v) |
| filter_hint_size_x | ue(v) |
| filter_hint_type | u(2) |
| filter_hint_chroma_coeff_present_flag | u(1) |
| for( cIdx = 0; cIdx < | |
| (filter_hint_chroma_coeff_present_flag ? 3 : 1); cIdx++ ) | |
| for( cy = 0; cy < filter_hint_size_y; cy++ ) | |
| for( cx = 0; cx < filter_hint_size_x; cx++ ) | |
| filter_hint_value[ cIdx ][ cy ][ cx ] | se(v) |
| } | |

In Table 9, filter_hint_size_y, filter_hint_size_x, filter_hint_type, and filter_hint_value may be the same as those described in the section Post-filter hint above.

filter_hint_chroma_coeff_present_flag set to 1 (i.e., the second value) may indicate that a filter coefficient for chroma is present. filter_hint_chroma_coeff_present_flag set to 0 (i.e., the first value) may indicate that the filter coefficient for chroma is not present.

### EMBODIMENT 1-4

Table 10 below shows an example of the post-filter hint SEI message. The post-filter hint SEI message in Table 10 below may provide coefficients or correlation information for the design of a post-filter for potential use in post-processing of the current picture after decoding of the current picture. Thereby, improved display quality may be obtained.

TABLE 10

| | Descriptor |
|---|---|
| post_filter_hint( payloadSize ) { | |
| filter_hint_size_y | ue(v) |
| filter_hint_size_x | ue(v) |
| filter_hint_type | u(2) |
| filter_hint_chroma_coeff_present_flag | u(1) |
| if( filter_hint_chroma_coeff_present_flag) | |
| filter_hint_single_set_chroma_coeff_flag | u(1) |
| for( cIdx = 0; | |
| cIdx < (filter_hint_chroma_coeff_present_flag ? | |
| (filter_hint_single_set_chroma_coeff_flag ? 2 : 3) : 1); cIdx++ ) | |
| for( cy = 0; cy < filter_hint_size_y; cy++ ) | |
| for( cx = 0; cx < filter_hint_size_x; cx++ ) | |
| filter_hint_value[ cIdx ][ cy ][ cx ] | se(v) |
| } | |

In Table 10, filter_hint_size_y, filter_hint_size_x, and filter_hint_type may be the same as those described in the section Post-filter hint above.

filter_hint_chroma_coeff_present_flag set to 1 (i.e., the second value) may indicate that a filter coefficient for chroma is present.

filter_hint_chroma_coeff_present_flag set to 0 (i.e., the first value) may indicate that the filter coefficient for chroma is not present.

filter_hint_single_set_chroma_coeff_flag set to 1 (i.e., the second value) may

indicate that the same filter set is applied to all chroma components. filter_hint_single_set_chroma_coeff_flag set to 0 (i.e., the first value) may indicate that each chroma component may have a different filter coefficient.

The filter_hint_value[cIdx][cy][cx] may be the same as described in the section Post-filter hint above. According to the present disclosure, when filter_hint_single_set_chroma_coeff_flag is equal to 1, filter_hint_value[2][cy][cx] may be inferred to have the same value as filter_hint_value[1][cy][cx]. Here, cy may be in the range of 0 to filter_hint_size_y−1, and cx may be in the range of 0 to filter_hint_size_x−1.

### EMBODIMENT 2

Filter operations that may be applied to a reconstructed picture may be signaled using a post-filter hint SEI message. However, the current syntax and semantics of the post-filter hint SEI message may be specified to be applied only to pictures with the same layer as the SEI message and to the access unit containing the SEI message. It is not uncommon for the same filter to be applied to multiple consecutive pictures. In such cases, when using the current post-filter hint SEI message, the same SEI message must be transmitted/included in each access unit, which may cause unnecessary duplication. Therefore, it may be preferred that the persistence of the post-filter hint SEI message may be extended to two or more pictures.

To address this issue, the present disclosure proposes the following embodiments. Each of the following embodiments may be performed separately, or a combination of two or more embodiments may be performed.

1. Persistence of the post-filter hint SEI message may be allowed for one or more pictures.

2. The post-filter hint SEI message may be applied for pictures that satisfy at least one of the following conditions:
a. The pictures must all belong to the same layer:
b. The pictures must be consecutive in output order.

3. A flag indicating whether the post-filter hint SEI message is an SEI message that cancels the persistence of a previous post-filter hint SEI message in the same layer may be signaled.

4. A flag may be signaled to specify whether the post-filter hint SEI message persists only for pictures with the same layer within the same access unit, or whether it persists for subsequent pictures in the same layer until persistence is canceled by one of the following conditions:
a. A new CLVS in the current layer is started:
b. The end of a bitstream
c. A picture in the current layer in an AU associated with a post-filter hint SEI message is output that follows the current picture in output order.

5. Alternatively, an indication for persistence of the SEI message may be signaled. In this case, the value of the indication may be interpreted as follows:
a. When the value of the indication is 0 (i.e., the first value), the SEI message may be applied to only the picture associated with the SEI message.
b. When the value of the indication is 1 (i.e., the second value), the SEI message may be applied to the picture associated with the SEI message and subsequent pictures until an event occurs that cancels the SEI message.
c. When the value of the indication is 2 (i.e., the third value), the SEI message may cancel the earlier SEI message.

### EMBODIMENT 2-1

Table 11 below shows an example of the post-filter hint SEI message. The post-filter hint SEI message in Table 11 below may provide coefficients or correlation information for the design of a post-filter for potential use in post-processing of the current picture after decoding of the current picture. Thereby, improved display quality may be obtained.

TABLE 11

| | Descriptor |
|---|---|
| post_filter_hint( payloadSize ) { | |
| filter_hint_cancel_flag | u(1) |
| if( !filter_hint_cancel_flag ) { | |
| filter_hint_persistence_flag | u(1) |
| filter_hint_size_y | ue(v) |
| filter_hint_size_x | ue(v) |
| filter_hint_type | u(2) |
| for( cIdx = 0; cIdx < ( chroma_format_idc = = 0 ? 1 : 3 ); cIdx++ ) | |
| for( cy = 0; cy < filter_hint_size_y; cy++ ) | |
| for( cx = 0; cx < filter_hint_size_x; cx++ ) | |
| filter_hint_value[ cIdx ][ cy ][ cx ] | se(v) |
| } | |
| } | |

In Table 11, filter_hint_size_y, filter_hint_size_x, filter_hint_type, and filter_hint_value[cIdx][cy][cx] may be the same as those described in the section Post-filter hint above.

filter_hint_cancel_flag equal to 1 (i.e., the second value) may indicate that the SEI message cancels the persistence of all earlier post-filter hint SEI messages applied to the current layer in output order. filter_hint_cancel_flag equal to 0 (i.e., the first value) may indicate that the post-filter hint information follows. That is, based on filter_hint_cancel_flag, the post-filter hint information (i.e., filter_hint_persistence_flag) may be acquired. For example, when the value of filter_hint_cancel_flag is 0 (i.e., the first value), filter_hint_persistence_flag may be acquired.

filter_hint_persistence_flag may indicate the persistence of the post-filter hint SEI message for the current layer. filter_hint_persistence_flag equal to 0 (i.e., the first value) may indicate that the post-filter hint SEI message is applied to only the current decoded picture. When the value of filter_hint_persistence_flag is 1 (i.e., the second value), the post-filter hint SEI message may persist for the current decoded picture and for subsequent pictures in the current layer in output order until one of the following conditions are satisfied:
A new CLVS in the current layer is started:
The end of a bitstream:
A picture in the current layer in an AU associated with a post-filter hint SEI message is output that follows the current picture in output order.

### EMBODIMENT 2-2

Table 12 below shows an example of the post-filter hint SEI message. The post-filter hint SEI message in Table 12 below may provide coefficients or correlation information for the design of a post-filter for potential use in post-processing of the current picture after decoding of the current picture. Thereby, improved display quality may be obtained.

TABLE 12

| | Descriptor |
|---|---|
| post_filter_hint( payloadSize ) { | |
| filter_hint_persistence_idc | ue(v) |
| if ( filter_hint_persistence_idc != 2) { | |
| filter_hint_size_y | ue(v) |
| filter_hint_size_x | ue(v) |
| filter_hint_type | u(2) |
| for( cIdx = 0; cIdx < ( chroma_format_idc = = 0 ? 1 : 3 ); cIdx++ ) | |
| for( cy = 0; cy < filter_hint_size_y; cy++ ) | |
| for( cx = 0; cx < filter_hint_size_x; cx++ ) | |
| filter_hint_value[ cIdx ][ cy ][ cx ] | se(v) |
| } | |
| } | |

In Table 12, filter_hint_size_y, filter_hint_size_x, filter_hint_type, and filter_hint_value[cIdx][cy][cx] may be the same as those described in the section Post-filter hint above.

filter_hint_persistence_idc may indicate the persistence of the post-filter hint SEI message for the current layer. filter_hint_persistence_idc equal to 0 (i.e., the first value) may indicate that the post-filter hint SEI message is applied to only the current decoded picture. When the value of filter_hint_persistence_idc is 1 (i.e., the second value), the post-filter hint SEI message may persist for the current decoded picture and for subsequent pictures in the current layer in output order until one of the following conditions are satisfied:
A new CLVS in the current layer is started:
The end of a bitstream;
A picture in the current layer in an AU associated with a post-filter hint SEI message is output that follows the current picture in output order.

filter_hint_persistence_idc equal to 2 (i.e., the third value) may indicate that the SEI message cancels the persistence of all earlier post-filter hint SEI messages applied to the current layer in output order. In other words, when the value of filter_hint_persistence_idc is 2 (i.e., the third value), the persistence of post-filter hint SEI messages may be canceled.

### EMBODIMENT 2-3

Table 13 below shows an example of the post-filter hint SEI message. The post-filter hint SEI message in Table 13 below may provide coefficients or correlation information for the design of a post-filter for potential use in post-processing of the current picture after decoding of the current picture. Thereby, improved display quality may be obtained.

TABLE 13

| | Descriptor |
|---|---|
| post_filter_hint( payloadSize ) { | |
| filter_hint_enabled_flag | u(1) |
| if( filter_hint_enabled_flag ) { | |
| filter_hint_persistence_flag | u(1) |
| filter_hint_size_y | ue(v) |
| filter_hint_size_x | ue(v) |
| filter_hint_type | u(2) |
| for( cIdx = 0; cIdx < ( chroma_format_idc = = 0 ? 1 : 3 ); cIdx++ ) | |
| for( cy = 0; cy < filter_hint_size_y; cy++ ) | |
| for( cx = 0; cx < filter_hint_size_x; cx++ ) | |
| filter_hint_value[ cIdx ][ cy ][ cx ] | se(v) |
| } | |
| } | |

In Table 13, filter_hint_size_y, filter_hint_size_x, filter_hint_type, and filter_hint_value[cIdx][cy][cx] may be the same as those described in the section Post-filter hint above.

filter_hint_enable_flag equal to 0 (i.e., the first value) may indicate that the SEI message is not available for the persistence of all earlier post-filter hint SEI messages applied to the current layer in output order. filter_hint_enable_flag equal to 1 (i.e., the second value) may indicate that the post-filter hint information follows. That is, based on filter_hint_enable_flag, the post-filter hint information (i.e., filter_hint_persistence_flag) may be acquired. For example, when the value of filter_hint_enable_flag is 1 (i.e., the second value), filter_hint_persistence_flag may be acquired.

filter_hint_persistence_flag may indicate the persistence of the post-filter hint SEI message for the current layer. filter_hint_persistence_flag equal to 0 (i.e., the first value) may indicate that the post-filter hint SEI message is applied to only the current decoded picture. When the value of filter_hint_persistence_flag is 1 (i.e., the second value), the post-filter hint SEI message may persist for the current decoded picture and for subsequent pictures in the current layer in output order until one of the following conditions are satisfied:
A new CLVS in the current layer is started:
The end of a bitstream:
A picture in the current layer in an AU associated with a post-filter hint SEI message is output that follows the current picture in output order.

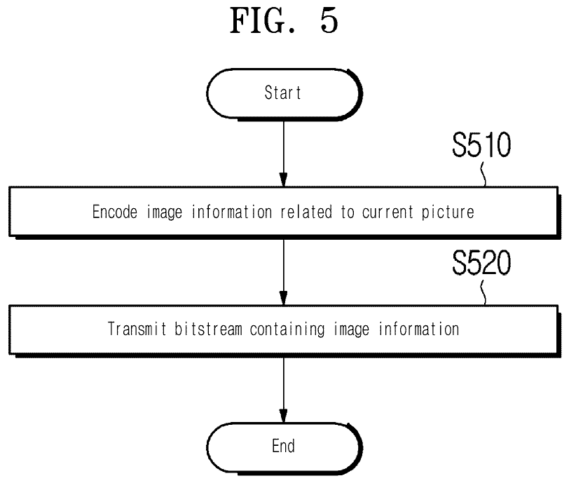

FIG. 5 is a flowchart of an image encoding method according to the present disclosure. Referring to FIG. 5, the image encoding apparatus 100 may encode image information related to a current picture (S510). The image encoding apparatus 100 may then transmit a bitstream containing the image information (S520). Here, the image information may include a post-filter hint SEI message related to a post-filter to be applied to a reconstructed picture.

According to one embodiment of the present disclosure, the post-filter hint SEI message may contain filter coefficient information indicating whether a filter coefficient for chorma components is present. Here, the filter coefficient information may be filter_hint_chroma_coeff_present_flag. Based on the filter coefficient information, the image encoding apparatus 100 may encode, from the post-filter hint SEI message, single-set filter coefficient information indicating whether the same filter coefficient set is applied to all the chroma components. Here, the single-set filter coefficient information may be filter_hint_single_set_chroma_coeff_flag.

According to another embodiment of the present disclosure, the post-filter hint SEI message may contain chroma format information indicating chroma sampling related to luma sampling. Here, the chroma format information may be filter_hint_chroma_format_idc. Based on the chroma format information, the image encoding apparatus 100 may encode, from the post-filter hint SEI message, filter coefficient information indicating whether a filter coefficient for the chorma components is present. Here, the filter coefficient information may be filter_hint_chroma_coeff_present_flag.

According to another embodiment of the present disclosure, the post-filter hint SEI message may contain filter hint cancel information indicating whether to cancel use of a post-filter hint SEI message used for an earlier picture in output order. Here, the filter hint cancel information may be filter_hint_cancel_flag. Based on the filter hint cancel information, the image encoding apparatus 100 may encode, from the post-filter hint SEI message, filter hint persistence information indicating whether the post-filter hint SEI message is used for other pictures following the current picture in the output order. Here, the filter hint persistence information may be filter_hint_persistence_flag.

The filter hint persistence information having a first value (i.e., 0) may indicate that the post-filter hint SEI message is applicable to only the current reconstructed picture. The filter hint persistence information having a second value (i.e., 1) may indicate that the post-filter hint SEI message is also applicable to other pictures in the current layer that follow the current reconstructed picture in the output order. In this case (when the value of the filter hint persistence information is the second value (i.e., 1)), it may indicate that the post-filter hint SEI message is applied until a new CLVS in the current layer is started. Alternatively, when the value of the filter hint persistence information is the second value (i.e., 1), it may indicate that the post-filter hint SEI message is applied until the end of the bitstream. Alternatively, when the value of the filter hint duration information is the second value (i.e., 1), it may indicate that the post-filter hint SEI message is applied until the next picture in the current layer within an access unit related to the post-filter hint SEI message in the output order is output.

According to one embodiment of the present disclosure, the post-filter hint SEI message may contain filter hint persistence information indicating persistence of the post-filter hint SEI message for the current layer. Here, the filter hint persistence information may be filter_hint_persistence_idc. When the value of the filter hint persistence information is the first value (i.e., 0)), the post-filter hint SEI message may be applied to only the current decoded picture.

When the value of the filter hint persistence information is the second value (i.e., 1), the post-filter hint SEI message may also be applied to other pictures in the current layer that follow the current reconstructed picture in the output order. In this case (when the value of the filter hint persistence information is the second value), the post-filter hint SEI message may be applied until a new CLVS in the current layer is started. Alternatively, the post-filter hint SEI message may be applied until the end of the bitstream. Alternatively, the post-filter hint SEI message may be applied until the next picture in the current layer within the access unit related to the post-filter hint SEI message in the output order is output.

When the value of the filter hint persistence information is a third value (i.e., 2), the persistence of the post-filter hint SEI message may be canceled. In other words, the post-filter hint SEI message may no longer be applied for subsequent pictures.

According to another embodiment of the present disclosure, the post-filter hint SEI message may contain filter hint availability information indicating whether the post-filter hint SEI message is available. Here, the filter hint enabled information may be filter_hint_enabled_flag. Based on the filter hint availability information, the image encoding apparatus 100 may encode, from the post-filter hint SEI message, filter hint persistence information indicating whether the post-filter hint SEI message is used for other pictures that follow the current picture in the output order. Here, the filter hint persistence information may be filter_hint_persistence_flag. In other words, the filter hint persistence information may be determined based on filter hint availability information.

Based on the filter hint persistence information having the first value (i.e., 0), the post-filter hint SEI message may be applied to only the current reconstructed picture. Based on the value of the filter hint persistence information being the second value (i.e., 1), the post-filter hint SEI message may also be applied to other pictures in the current layer that follow the current reconstructed picture in the output order.

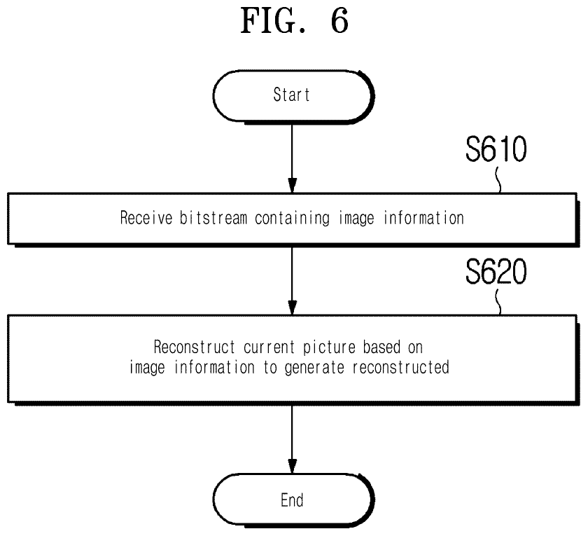

FIG. 6 is a flowchart of an image decoding method according to the present disclosure. Referring to FIG. 6, the image decoding apparatus 200 may receive a bitstream containing image information (S610). The image decoding apparatus 200 may then reconstruct the current picture based on the image information to generate a reconstructed picture (S620). In this case, the image information may include a post-filter hint SEI message related to a post-filter to be applied to the reconstructed picture.

According to one embodiment of the present disclosure, the post-filter hint SEI message may contain filter coefficient information indicating whether a filter coefficient for chroma components is present. Here, the filter coefficient information may be filter_hint_chroma_coeff_present_flag. Based on the filter coefficient information, the image decoding apparatus 200 may acquire, from the post-filter hint SEI message, single-set filter coefficient information indicating whether the same filter coefficient set is applied to all the chroma components. Here, the single-set filter coefficient information may be filter_hint_single_set_chroma_coeff_flag.

According to another embodiment of the present disclosure, the post-filter hint SEI message may contain chroma format information indicating chroma sampling related to luma sampling. Here, the chroma format information may be filter_hint_chroma_format_idc. Based on the chroma format information, the image decoding apparatus 200 may acquire, from the post-filter hint SEI message, filter coefficient information indicating whether a filter coefficient for chroma components is present. Here, the filter coefficient information may be filter_hint_chroma_coeff_present_flag.

According to another embodiment of the present disclosure, the post-filter hint SEI message may contain filter hint cancel information indicating whether to cancel use of a post-filter hint SEI message used for an earlier picture in output order. Here, the filter hint cancel information may be filter_hint_cancel_flag. Based on the filter hint cancel information, the image decoding apparatus 200 may acquire, from the post-filter hint SEI message, filter hint persistence information indicating whether the post-filter hint SEI message is used for other pictures following the current picture in the output order. Here, the filter hint persistence information may be filter_hint_persistence_flag.

Based on the filter hint persistence information having the first value (i.e., 0)), the post-filter hint SEI message may be applied to only the current reconstructed picture. Based on the filter hint persistence information having the second value (i.e., 1), the post-filter hint SEI message may also be applied to other pictures in the current layer that follow the current reconstructed picture in the output order. In this case (when the value of the filter hint persistence information is the second value (i.e., 1)), the post-filter hint SEI message may be applied until a new CLVS is started in the current layer. Alternatively, when the value of the filter hint persistence information is the second value (i.e., 1), the post-filter hint SEI message may be applied until the end of the bitstream. Alternatively, when the value of the filter hint persistence information is the second value (i.e., 1), the post-filter hint SEI message may be applied until the next picture in the current layer within the access unit related to the post-filter hint SEI message in the output order is output.

According to one embodiment of the present disclosure, the post-filter hint SEI message may contain filter hint persistence information indicating persistence of the post-filter hint SEI message for the current layer. Here, the filter hint persistence information may be filter_hint_persistence_idc. When the value of the filter hint persistence information is the first value (i.e., 0)), the post-filter hint SEI message may be applied to only the current decoded picture.

When the value of the filter hint persistence information is the second value (i.e., 1), the post-filter hint SEI message may also be applied to other pictures in the current layer that follow the current reconstructed picture in the output order. In this case (when the value of the filter hint persistence information is 2), the post-filter hint SEI message may be applied until a new CLVS is started in the current layer. Alternatively, the post-filter hint SEI message may be applied until the end of the bitstream. Alternatively, the post-filter hint SEI message may be applied until the next picture in the current layer within the access unit related to the post-filter hint SEI message in the output order is output.

When the value of the filter hint persistence information is a third value (i.e., 2), the persistence of the post-filter hint SEI message may be canceled. In other words, the post-filter hint SEI message may no longer be applied for subsequent pictures.

According to another embodiment of the present disclosure. the post-filter hint SEI message may contain filter hint availability information indicating whether the post-filter hint SEI message is available. Here, the filter hint enabled information may be filter_hint_enabled_flag. Based on the filter hint availability information, the image decoding apparatus 200 may acquire, from the post-filter hint SEI message, filter hint persistence information indicating whether the post-filter hint SEI message is used for other pictures that follow the current picture in the output order. Here, the filter hint persistence information may be filter_hint_persistence_flag. In other words, the filter hint persistence information may be determined based on filter hint availability information.

Based on the filter hint persistence information having the first value (i.e., 0), the post-filter hint SEI message may be applied to only the current reconstructed picture. Based on the value of the filter hint persistence information being the second value (i.e., 1), the post-filter hint SEI message may also be applied to other pictures in the current layer that follow the current reconstructed picture in the output order.

While the exemplary methods of the present disclosure described above are represented as a series of operations for clarity of description, it is not intended to limit the order in which the operations are performed, and the operations may be performed simultaneously or in different order as necessary. In order to implement the method according to the present disclosure, the described operations may further include other operations, may include remaining operations except for some of the operations, or may include other additional operations except for some operations.

In the present disclosure, the image encoding apparatus 100 or the image decoding apparatus 200 that performs a predetermined operation (step) may perform an operation (step) of confirming an execution condition or situation of the corresponding operation (step). For example, if it is described that predetermined operation is performed when a predetermined condition is satisfied, the image encoding apparatus 100 or the image decoding apparatus 200 may perform the predetermined operation after determining whether the predetermined condition is satisfied.

The various embodiments of the present disclosure are not a list of all possible combinations and are intended to describe representative aspects of the present disclosure, and the matters described in the various embodiments may be applied independently or two or more thereof may be applied in combination.

Various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

In addition, the image decoding apparatus 200 and the image encoding apparatus 100, to which the embodiments of the present disclosure are applied, may be included in a multimedia broadcasting transmission and reception device, a mobile communication terminal, a home cinema video device, a digital cinema video device, a surveillance camera, a video chat device, a real time communication device such as video communication, a mobile streaming device, a storage medium, a camcorder, a video on demand (VOD) service providing device, an OTT video (over the top video) device, an Internet streaming service providing device, a three-dimensional (3D) video device, a video telephony video device, a medical video device, and the like, and may be used to process video signals or data signals. For example, the OTT video devices may include a game console, a Blu-ray player, an Internet access TV, a home theater system, a smartphone, a tablet PC, a digital video recorder (DVR), or the like.

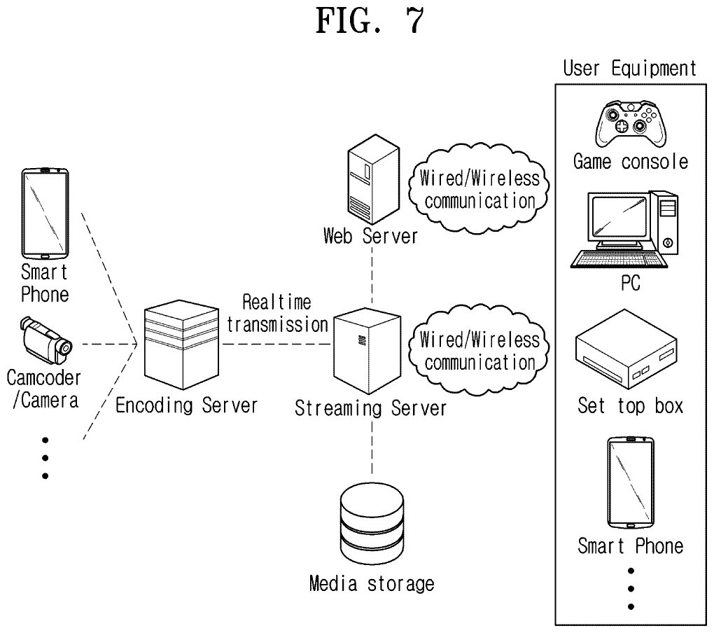

FIG. 7 is a diagram illustrating an exemplary content streaming system to which embodiments of the present disclosure are applicable.

As shown in FIG. 7, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus 100, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user devices may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable instructions (e.g., an operating system, an application, firmware, a program, etc.) for enabling operations according to the methods of various embodiments to be executed on an apparatus or a computer, a non-transitory computer-readable medium having such software or instructions stored thereon and executable on the apparatus or the computer.

The embodiments of the present disclosure may be used to encode or decode images.

What is claimed is:

1. An image decoding method performed by an image decoding apparatus, the method comprising:
receiving a bitstream containing image information; and
generating a reconstructed picture by reconstructing a current picture based on the image information,
wherein the image information comprises a post-filter hint Supplemental Enhancement Information (SEI) message related to a post-filter to be applied to the reconstructed picture.

2. The image decoding method of claim 1, wherein the post-filter hint SEI message contains filter coefficient information indicating whether a filter coefficient for chroma components is present.

3. The image decoding method of claim 1, wherein the post-filter hint SEI message contains chroma format information indicating chroma sampling related to luma sampling,
wherein, based on the chroma format information, filter coefficient information indicating whether a filter coefficient for chroma components is present is acquired from the post-filter hint SEI message.

4. The image decoding method of claim 2, wherein, based on the filter coefficient information, single-set filter coefficient information indicating whether the same filter coefficient set is applied to all the chroma components is acquired from the post-filter hint SEI message.

5. The image decoding method of claim 1, wherein the post-filter hint SEI message comprises filter hint cancel information indicating whether to cancel use of a post-filter hint SEI message used for an earlier picture in output order,
wherein, based on the filter hint cancel information, filter hint persistence information indicating whether the post-filter hint SEI message is used for other pictures following the current picture in the output order is acquired from the post-filter hint SEI message,
wherein:
based on the filter hint persistence information having a first value, the post-filter hint SEI message is applied to only a current reconstructed picture; and
based on the filter hint persistence information having a second value, the post-filter hint SEI message is applied to other pictures in a current layer following the current reconstructed picture in the output order.

6. The image decoding method of claim 5, wherein, based on the filter hint persistence information having the second value, the post-filter hint SEI message is applied until a new coded layer video sequence (CLVS) starts in the current layer.

7. The image decoding method of claim 5, wherein, based on the filter hint persistence information having the second value, the post-filter hint SEI message is applied until a next picture in the current layer within an access unit (AU) related to the post-filter hint SEI message in the output order is output.

8. The image decoding method of claim 1, wherein the post-filter hint SEI message contains filter hint persistence information indicating persistence of the post-filter hint SEI message for a current layer,
wherein:
based on the filter hint persistence information having a first value, the post-filter hint SEI message is applied to only a current reconstructed picture;
based on the filter hint persistence information having a second value, the post-filter hint SEI message is applied to other pictures in a current layer following the current reconstructed picture in output order; and
based on the filter hint persistence information having a third value, the persistence of the post-filter hint SEI message is canceled.

9. The image decoding method of claim 8, wherein, based on the filter hint persistence information having the second value, the post-filter hint SEI message is applied until a new coded layer video sequence (CLVS) starts in the current layer.

10. The image decoding method of claim 8, wherein, based on the filter hint persistence information having the second value, the post-filter hint SEI message is applied until a next picture in the current layer within an access unit (AU) related to the post-filter hint SEI message in the output order is output.

11. The image decoding method of claim 1, wherein the post-filter hint SEI message contains filter hint availability information indicating whether the post-filter hint SEI message is available,
wherein, based on the filter hint availability information, filter hint persistence information indicating whether the post-filter hint SEI message is used for other pictures following the current picture in the output order is acquired from the post-filter hint SEI message,
wherein the filter hint persistence information is determined based on the filter hint availability information,
wherein:
based on the filter hint persistence information having a first value, the post-filter hint SEI message is applied to only a current reconstructed picture; and
based on the filter hint persistence information having a second value, the post-filter hint SEI message is applied to other pictures in a current layer following the current reconstructed picture in the output order.

12. An image encoding method performed by an image encoding apparatus, the method comprising:
encoding image information related to a current picture; and
transmitting a bitstream containing the image information,
wherein the image information comprises a post-filter hint Supplemental Enhancement Information (SEI) message related to a post-filter applied to the current picture.

13. A computer-readable recording medium storing a bitstream generated by the image encoding method of claim 12.

14. A method of transmitting a bitstream generated by an image encoding method, the image encoding method comprising:
encoding image information related to a current picture; and
transmitting a bitstream containing the image information,
wherein the image information comprises a post-filter hint Supplemental Enhancement Information (SEI) message related to a post-filter applied to the current picture.
